(19) United States
(12) Patent Application Publication
(10) Pub. No.: US 2016/0375380 A1
(43) Pub. Date: Dec. 29, 2016

(54) CROSS-FLOW FILTER ASSEMBLY WITH IMPROVED CLEANING ASSEMBLY

(71) Applicant: DOW GLOBAL TECHNOLOGIES LLC, Midland, MI (US)

(72) Inventors: Rashi Tiwari, Missouri City, TX (US); Chad V. Schuette, Freeland, MI (US); Peter J. Schulz, Midland, MI (US); Mark O. Labonville, Sanford, MI (US); Jim M. Grider, Jr., Colon, MI (US); Gerald Drouin Corcoran, Santa Clara, CA (US)

(21) Appl. No.: 15/118,916

(22) PCT Filed: Dec. 3, 2014
(86) PCT No.: PCT/US2014/068252

§ 371 Date: Aug. 15, 2016

Related U.S. Application Data
(60) Provisional application No. 61/952,896, filed on Mar. 14, 2014.

(51) Int. Cl. B01D 29/64; B01D 29/11

(52) U.S. Cl. CPC B01D 29/6415; B01D 29/118

(57) ABSTRACT

A cross-flow filter assembly (10) including: a cylindrical filter (12) having an inner periphery (14) enclosing filter region (26) extending along an axis (X) from an opposing feed end (16) and an effluent end (18); and a cleaning assembly (32) axially-aligned within the filter region (26) and comprising at least one radially extending cleaning member (34) biased against the inner periphery (14) of the filter (12), wherein the cleaning assembly (32) is adapted to rotate about the axis (X) to remove debris from the inner periphery (14) of the filter (12); and is characterized by a compressive member (40) providing a continuous radially outward force that biases the cleaning member (34) against the inner periphery (14) of the porous screen (24).

### FIELD

The invention generally relates to cross-flow fluid filter devices.

### INTRODUCTION

In cross-flow filtration, a portion of feed liquid passes through a porous membrane or screen as “filtrate” while the remaining residual mixture flows past the membrane as a concentrated retentate or “effluent.” An example of a cross-flow filtration device is described in US2011/0220586. This device includes an annular cross-flow filter wherein feed liquid flows into the inner periphery of a cylindrical filter. Filtrate passes radially outward through the filter with effluent passing axially from the filter by way of an effluent outlet. The device includes a cylindrically-shaped rotating cleaning assembly located within the filter that further includes a cleaning member that removes debris from the inner surface of the filter. In one embodiment, the cleaning assembly is driven by the flow of feed liquid passing through the filter. See also WO2004/064978, U.S. Pat. No. 1,107,485 and U.S. Pat. No. 5,466,384. While partially effective, particulate matter can still become lodged with the pores of the filter, particularly as the cleaning member wears over time.

### SUMMARY

In one embodiment the invention includes a cross-flow filter assembly (10) including:

(i) a cylindrical filter (12) comprising a porous screen (24) defining an inner periphery (14) enclosing filter region (26) extending along an axis (X) from an opposing feed end (16) and an effluent end (18);

(ii) a feed inlet (20) located adjacent to the feed end (16), and an effluent outlet (22) located adjacent to the effluent end (18), wherein both the feed inlet (20) and effluent outlet (22) are in fluid communication with the filter region (26); and

(iii) a cleaning assembly (32) axially-aligned within the filter region (26) and comprising at least one radially extending cleaning member (34) biased against the inner periphery (14) of the filter (12), wherein the cleaning assembly (32) is adapted to rotate about the axis (X) to remove debris from the inner periphery (14) of the filter (12);

wherein the filter assembly (10) is characterized a compressive member (40) providing a continuous radially outward force that biases the cleaning member (34) against the inner periphery (14) of the screen (24).

Additional embodiments are described.

### BRIEF DESCRIPTION OF THE DRAWINGS

The Figures are not to scale and include idealized views to facilitate description. Where possible, like numerals have been used throughout the figures and written description to designate the same or similar features.

FIG. 1 is an exploded perspective view of an embodiment of the invention.

FIG. 2 is a cross-sectional elevational view illustrating fluid flow through the embodiment of FIG. 1.

FIG. 3 is a perspective view of an embodiment of the cleaning assembly (32).

FIG. 4 is an elevational view of an alternative embodiment of a cleaning assembly (32) showing the cleaning member (34) biased against the inner periphery (14) of the porous screen (24) by a compressive member (40).

FIG. 5A is an enlarged simplified elevation view of the porous screen (24) showing an idealized particle (42) lodged with a pore (25).

FIG. 5B is a view of the embodiment of FIG. 5A showing the porous screen (24) radially deforming in response to a cleaning member (34) biased against and moving across the screen (24) and dislodging a particle (42) form a pore (25).

FIG. 6 is an exploded perspective view of another embodiment of the filter assembly (12).

FIG. 7 is a cross-sectional elevational view of another embodiment of the invention.

### DETAILED DESCRIPTION

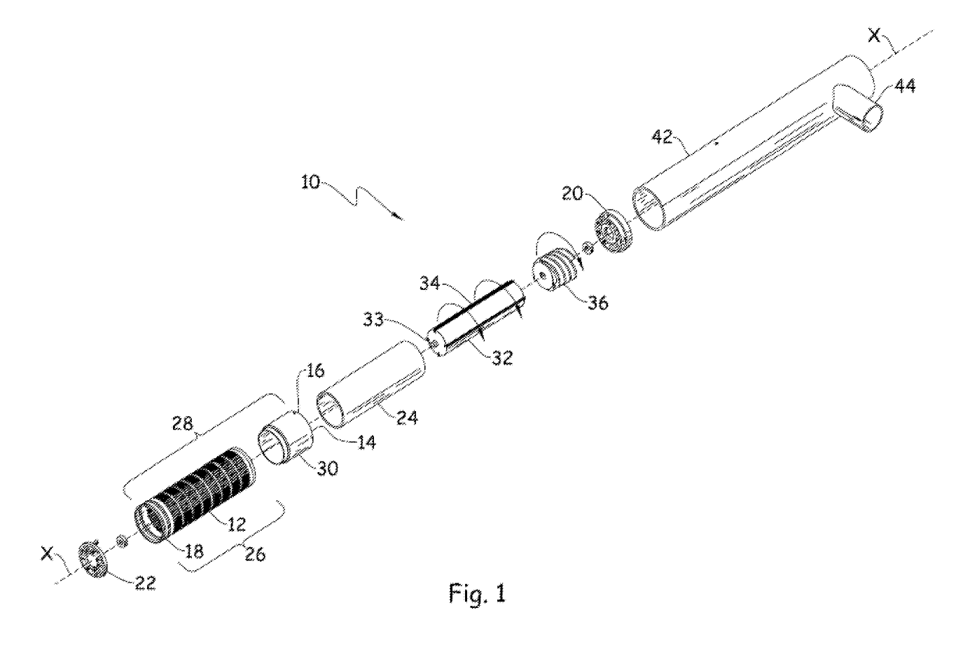

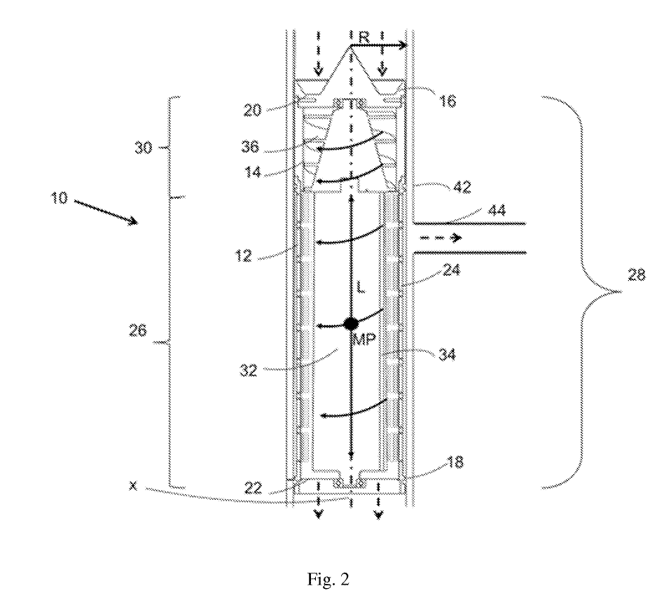

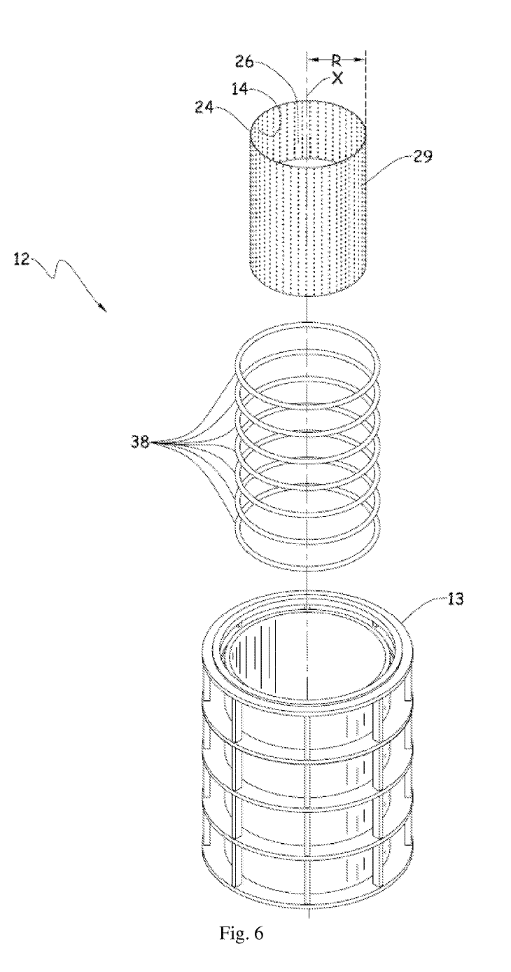

With reference to the FIGS. 1 and 2, a preferred embodiment of the cross-flow filter assembly is generally shown at 10 including a filter (12) including a porous screen (24) that defines an inner periphery (14) extending along an axis (X) and enclosing an axially aligned filter region (26) between an opposing feed end (16) and an effluent end (18). While shown as being cylindrical, the filter (12) and its inner periphery (14) may independently have alternative configurations, e.g. frustro-conical, elliptical, polygonal, etc. However, in a preferred embodiment the inner periphery (14) has an elliptical, and more preferably, circular cross-section. The filter (12) may optionally include a cage or housing (13) for supporting the relatively finer porous screen (24) (discussed with reference to FIG. 6). In an alternative embodiment not shown, the cage (13) and porous screen (24) may form a single integral component part.

The porous screen (24) may be fabricated from a wide variety of materials include polymers, glass, ceramics and metals. The pore size (e.g. 1 to 500 micron as measured by SEM), shape (e.g. V-shape, cylindrical, slotted, mesh, etc.) and uniformity of the screen (24) may vary depending upon application. In many preferred embodiments, the screen (24) is relatively thin, e.g. from 0.1-0.4 mm and comprises a corrosion-resistant metal (e.g. electroformed nickel screen) including uniform sized pores (25) having sizes from 10 to 100 microns. Representative examples of such materials are described: U.S. Pat. No. 6,478,958, U.S. Pat. No. 7,632,416, U.S. Pat. No. 7,896,169, U.S. Pat. No. 8,201,697, US2005/0252838, US2012/0010063, US2012/0145609, US2013/0126421 and WO2012/154448 (US13/581578), the entire subject matter of each of which is incorporated herein by reference. While the porous screen (24) may be cast, molded or otherwise fabricated as a continuous circular component, in a preferred embodiment the screen is fabricated from a band of material that is flexed into a circle and secured at its ends to form a circular configuration.

The assembly (10) further includes a feed inlet (20) located adjacent to the feed end (16) and an effluent outlet (22) located adjacent to the effluent end (18) wherein both the feed inlet (20) and effluent outlet (22) are in fluid communication with the filter region (26). While shown as axially aligned, either or both of the feed inlet (20) and effluent outlet (22) may alternatively be located at a radial position located near the feed end (16) and effluent end (18), respectively.

The filter (12) may optionally form part of an elongated (e.g. cylindrical) body (28) including a feed section (30) located adjacent to the feed end (16) with the filter (12) located between the feed section (30) and the effluent end (18). In this context the term “between” refers to the relative location of the filter (12) and does not necessarily require that the filter (12) extend from the feed section (30) to the effluent end (18) as shown in the Figures. The feed section (30) and filter (12) may be an integral one-piece unit (e.g. injection molded) or may be fabricated as separate parts that are interconnected, e.g. via matching threads, adhesives, welds, fasteners, clamps, etc. Alternatively, the feed section (30) and filter (12) may be jointly connected to an intermediate member (not shown). In the illustrated embodiment, the feed inlet (20) is located adjacent to the feed end (16) and the effluent outlet (22) is located adjacent to the effluent end (18) at opposing ends of the body (28). As shown in the embodiment of FIG. 2, the feed section (30) preferably includes solid or non-permeable outer periphery. In an alternative embodiment not shown, the body (28) only includes the filter (12), i.e. the filter (12) extends continuously from the inlet to the effluent ends (16, 18).

The assembly 10 preferably includes a cleaning assembly (32) located within the filter region (26). The cleaning assembly (32) includes a central axial shaft or base (33) with at least one radially extending cleaning member (34) that extends directly along the axial length of the base (33), e.g. brush, wiper, etc. In an alternative embodiment not shown, the cleaning member (34) may extend a spiral path along the length of the base (33). The cleaning assembly (32) is adapted to rotate about the axis (X) to remove debris from the inner periphery (14) of the porous screen (24) of the filter (12). In one embodiment, the cleaning assembly (32) is driven about the central axial shaft (33) by a power source such as an electric motor. In an alternative embodiment, the cleaning assembly (32) includes an impeller (36) axially extending along at least a portion of the body (28), e.g. feed portion (30) in FIGS. 1 and 2. The impeller (36) is adapted to rotate the base (33) about the axis (X) as a result of feed fluid entering the assembly (10) from the feed inlet (20) and flowing through the inner periphery (14).

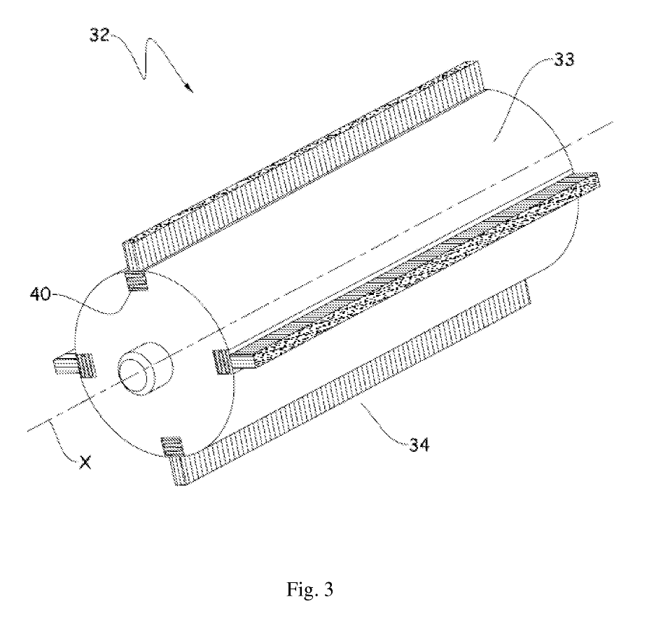

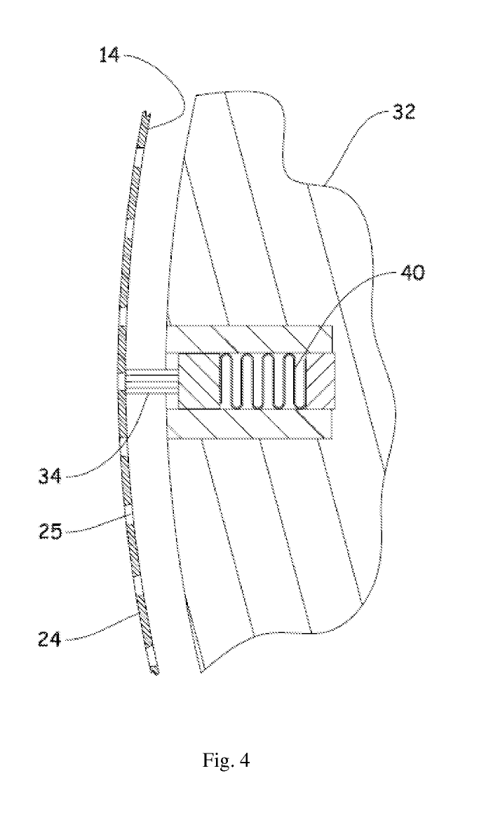

In another embodiment illustrated in FIGS. 3 and 4, the cleaning member (34) is movable in a radial direction and the cleaning assembly (32) further includes and a compressive member (40) that provides a continuous radially outward force that biases the cleaning member (34) against the inner periphery (14) of the porous screen (24). The compressive member (40) is not particularly limited and includes spring-loaded devices including various types of springs, e.g. coil, cantilever, volute, torsional, gas (cylinder with compressed gas), and the like. In a preferred embodiment, the compressive member (40) provides a continuous (e.g. +/10%) radially outward force against the cleaning member (34) even as the engaging portions between the cleaning member(s) (34) and screen (24) begin to wear. In this way, the cleaning member(s) (34) maintains a desired pre-determined biasing force against the inner periphery (14) of the screen (24) and provides a longer period of optimal operation. The compressive force of the compressive member (40) is may be selected to optimize performance based upon pore size, size and nature of the debris, filter type and type of cleaning member (e.g. brass fibers, nylon fibers, etc.). Preferred compressive forces range from 0.049 to 1 Newtons. In a further preferred embodiment, the cleaning assembly (32) includes a plurality of cleaning members (34) evenly spaced about and compressably-loaded against the inner periphery (14) of the filter (12). In a still more preferred embodiment, each of the cleaning members (34) exerts a substantially equivalent radial outward force (e.g. +/5%) against the inner periphery (14) of the filter (12). Such an embodiment stabilizes (e.g. reduces vibrations) the filter assembly (12) as turbulent fluid passes through the assembly (10) and the cleaning members (34) move across the filter (12). Such stabilization is particularly beneficial when utilizing a cleaning assembly (32) having a tapered or non-uniform dimension (as described below). This stability reduces wear and operational inefficiencies and is particularly beneficial when operating at high feed rates wherein the cleaning members (34) rotate about the filter (12) in excess of 60 RPMs, 100 RPMs, and even 1000 RPMs.

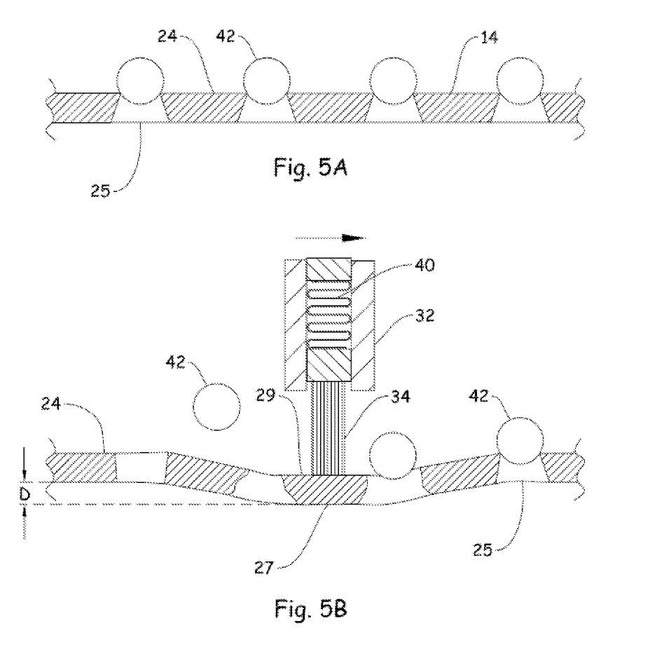

In yet another embodiment illustrated in FIGS. 5A and 5B, the porous screen (24) is reversibly deformable a predetermined radial distance (D) in response to the cleaning member (34) being biased against its inner periphery (14). The radial distance of deformation (D) is preferably from 0.1 to 10 times (more preferably 0.25 to 2 times) the average pore size. This degree of deformation alters the shape and/or size of the pores (25) such that entrapped particles (42) may be dislodged from the pores (25) while preventing excessive crazing or cracking of the screen (24).

In yet another embodiment illustrated in FIG. 6, a cage (13) maintains the porous screen (24) in a generally cylindrical configuration during operation but allows the porous screen (24) to reversibly deform a radial distance (D) in response to a cleaning member (34) biased against about the inner periphery (14) of the filter (12). A flexible member (38) (e.g. elastomeric O-rings, foam, 3/32 OD Viton A hollow tube, etc.) may be located between the cage (13) and the porous screen (24). While dependent upon the application, the flexible member (38) preferably has a Shore hardness durometer A value of from 20° to 100° as measured by ASTM D2240-05(2010).

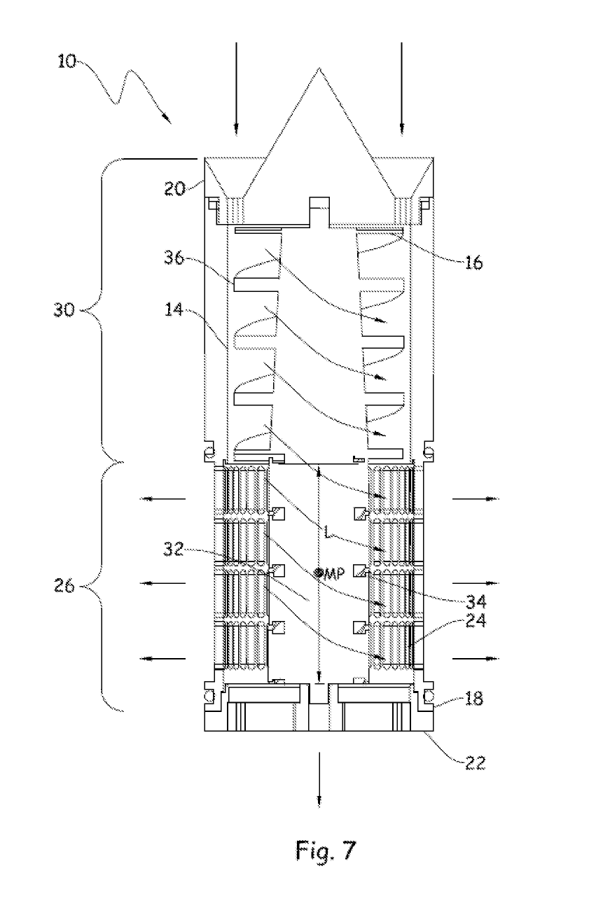

As shown in the embodiment illustrated in FIG. 7, the filter region (26) has a radius (R) and an axial mid-point (MP) along its axial length (L). The space within this region (26) defines a free volume that is in fluid communication with both the feed inlet (20) and effluent outlet (22). The free volume of the filter region (26) located between the mid-point (MP) and feed end (16) (i.e. the free volume located in the upper portion of the filter (12) shown in FIG. 2) is preferably at least 2.5% greater, and more preferably at least 5%, 10% and in some embodiments at least 15% greater, than the free volume of the filter region (26) between the mid-point (MP) and effluent end (18) (i.e. the free volume of bottom portion of filter (12) as shown in FIG. 2). This “fractional change” in free volume is preferably chosen to approximate the loss of volume of liquid as filtrate passes through the porous screen (24) along the axial length of the filter (12). In this way, loss in operating pressure is at least partially off-set and the overall separation efficiency of the assembly is improved. One means for reducing the free volume of the filter region (26) between the mid-point (MP) and effluent end (18) involves utilizing a cleaning assembly (32) that occupies a greater amount of space (free volume) between the mid-point (MP) and effluent end (18) as compared with the region between the mid-point (MP) and the feed end (16). For example, the axially centered base (33) of the cleaning assembly (32) may taper outward from the feed end (16) to the effluent end (18). Alternatively, the cleaning member(s) (34) may have a greater dimension near the effluent end (18) as compared with the feed end (16). In such an embodiment, the cleaning assembly (32) occupies at least 2.5%, 5%, 10% or even at least 15% more of the free volume of the filter region (26) between the mid-point (MP) and effluent end (16) as compared with the free volume of the filter region (26) between the mid-point and feed end (18).

As illustrated by the dotted arrows in FIG. 2, during operation feed liquid enters the inner periphery (14) of body (28) by way of the feed inlet (20) where it passes through the feed section (30) to the filter region (26) of the filter (12). Filtrate passes through the porous screen (24) of the filter (12) and exits the assembly (10) while residual effluent exits the filter region (24) by way of the effluent outlet (22). In the process of passing through the feed section (30), the feed liquid drives the impeller (36) of the cleaning assembly (32) which in turn rotates the cleaning member (34) about the central axis (X) to remove or otherwise prevent the accumulation of debris on the porous screen (24). Filtrate or effluent may be recycled and passed through the assembly (10) multiple times. The recovery of the assembly (10) during any single pass is the ratio of the volumetric rate of filtrate produced to the volumetric rate of total feed liquid entering the assembly (10). In a preferred embodiment, the recovery during a single pass is more than 5% and less than 50%, more preferably it is more than 10% and less than 30%. In operation, the ratio of the single pass recovery to the previously defined fractional change in the free volume is between 1 and 3.

As shown in FIGS. 1 and 2, the assembly (10) may further include an outer housing (42), such an axially aligned cylindrical pipe or shell fitted about the body (28). The housing (42) includes ports allowing fluid flow into and out of the body (28). The outer housing (42) may include optional seals that restrict feed flow from bypassing the feed inlet (22) and otherwise passing along the outside of the feed section (30). Seals may also be included such that filtrate exiting from the filter region (26) and through the filter (12) is collected in a filtrate collection zone between the outer periphery of the filter (12) and the inner periphery of the outer housing. The outer housing (42) may additionally include a port (44) in fluid communication with the filtrate collection zone for removing filtrate from the assembly (10).

The assembly (10) may be used to filter a wide variety of liquid mixtures including the separation of solid particles from a liquid mixture and separation of mixtures including liquids of differing densities (e.g. oil and water). Specific applications include the treatment of: pulp effluent generating by paper mills, process water generated by oil and gas recovery, food processing (olive oil), bilge water and municipal and industrial waste water.

Many embodiments of the invention have been described and in some instances certain embodiments, selections, ranges, constituents, or other features have been characterized as being “preferred.” Such designations of “preferred” features should in no way be interpreted as an essential or critical aspect of the invention. While shown in a vertical orientation (i.e. X-axis being vertical), the assembly (10) may assume alternative orientations, e.g. horizontal. While shown as a single operating unit, multiple assemblies may be coupled in parallel and serial arrangements with filtrate or effluent being used as feed for downstream assemblies.

1. A cross-flow filter assembly (10) comprising:
(i) a cylindrical filter (12) comprising a porous screen (24) defining an inner periphery (14) enclosing filter region (26) extending along an axis (X) from an opposing feed end (16) and an effluent end (18);
(ii) a feed inlet (20) located adjacent to the feed end (16), and an effluent outlet (22) located adjacent to the effluent end (18), wherein both the feed inlet (20) and effluent outlet (22) are in fluid communication with the filter region (26); and
(iii) a cleaning assembly (32) axially-aligned within the filter region (26) and comprising at least one radially extending cleaning member (34) biased against the inner periphery (14) of the filter (12), wherein the cleaning assembly (32) is adapted to rotate about the axis (X) to remove debris from the inner periphery (14) of the filter (12);
wherein the filter assembly (10) is characterized a compressive member (40) providing a continuous radially outward force that biases the cleaning member (34) against the inner periphery (14) of the porous screen (24).

2. The assembly (10) of claim 1 wherein the compressive member (40) comprises a spring-loaded device.

3. The filter assembly of claim 1 comprising a plurality of cleaning members (34) evenly spaced about the inner periphery (14) of the porous screen (24).

4. The assembly (10) of claim 3 wherein the cleaning members (34) each exert a substantially equivalent radial outward force against the inner periphery (14) of the porous screen.

5. The assembly (10) of claim 1 wherein cleaning assembly further comprises an impeller (36) adapted to rotate about the axis (X) as a result of feed fluid flowing through the assembly.

6. The assembly (10) of claim 1 wherein the porous screen (24) comprises a plurality of pores and is reversibly deformable a radial distance (D) of from 0.1 to 10 times the average pore size by the cleaning member (34) biased against about the inner periphery (14) of the porous screen.

7. The assembly (10) of claim 1 wherein the filter region (26) has an axial mid-point (MP) along its axial length (L) and defines a free volume in fluid communication with both the feed inlet (20) and effluent outlet (22); and wherein the cleaning assembly (32) occupies at least 2.5% more of the free volume of the filter region (26) between the mid-point (MP) and effluent end (18) as compared with the free volume of the filter region (26) between the mid-point (MP) and feed end.
